(19) United States
(12) Patent Application Publication
(10) Pub. No.: US 2013/0063043 A1
(43) Pub. Date: Mar. 14, 2013

(54) VOLTAGE RECTIFIER

(71) Applicant: MUESSLI DANIEL, Biel (CH)

(72) Inventor: MUESSLI DANIEL, Biel (CH)

(73) Assignee: FUTUR-TEC (HONG KONG) LIMITED, Hong Kong (CN)

(21) Appl. No.: 13/229,091

(22) Filed: Sep. 9, 2011

(51) Int. Cl. H05B 37/02; H02J 3/00

(52) U.S. Cl. 315/294; 307/11

(57) ABSTRACT

A voltage rectifying unit may comprise a first and a second charging unit connected in parallel. The charging units may each comprise a first rectifying diode and a second rectifying diode connected in series. A third and a fourth rectifying diode may be connected in series between the first and the second rectifying diodes and may have a first connecting node therebetween. A first capacitor and a second capacitor may be connected in series between the first and the second rectifying diodes and in parallel with the third and fourth rectifying diodes, and may have a second connecting node therebetween. The nodes of the charging units may be connected to an AC input wave form wherein the voltage rectifying unit may be configured to provide a continuously positive wave form to at least one load connected thereto.

### FIELD OF THE DISCLOSURE

This disclosure relates generally to rectifiers, and more particularly, to a voltage rectifier which may be configured to provide an AC to DC converting circuit.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Voltage rectifiers such as AC/DC converting circuits are widely used. For example, AC/DC converters are used in such things as motor controllers and light emitting diode (LED) drivers. Diode bridges, full or half bridges, are common circuit elements used to perform rectification of an oscillating output signal. A half bridge may comprise two diodes and a full bridge may comprise four diodes. Diode bridges are commonly used for the output rectification in switched-mode power supply circuits, such as push-pull, half bridge and full bridge topologies. For one polarity of the signal, electric current flows through one diode (in ON state) and not through the other (in OFF state). For the opposite polarity the diodes switch their states, the ON diode goes to OFF state and the OFF diode changes to ON state. This switching of the current flow between the two diodes results in rectification.

One example of an application of a full bridge rectifier is as a driver for light emitting diodes (LEDs). Incandescent light bulbs have been and are currently used in a large variety of lighting products. Recently, fluorescent lamps, particularly compact fluorescent lamps (CFLs), have been developed to overcome some of the drawbacks associated with the incandescent lamps. More recently, light emitting diode LED lamps have been developed to overcome some of the drawbacks associated with the incandescent and fluorescent lamp. An LED lamp is a solid-state lamp that uses LEDs as the source of light. An LED may comprise a conventional semiconductor light emitting diode or an organic or polymeric light emitting diode. LED lamps may have one or more advantages over incandescent and fluorescent lamps, for example, LED lamps do not contain mercury, they may turn on instantly, they may have a longer service life, they may have a smaller size, and they may have a greater efficiency.

However, there may be several problems associated with the application of conventional AC/DC converting circuits as drivers for LEDs or other devices. For example, voltage rectifiers currently used may not provide a desired output voltage wave form, the circuit may be complex and expensive, and/or the circuit may comprises large components.

What is needed is a voltage rectifier that overcomes at least some of the disadvantages associated with currently available voltage rectifiers.

### SUMMARY

In one aspect of the present disclosure, a voltage rectifying unit comprises a first charging unit. The first charging unit comprises a first rectifying diode and a second rectifying diode connected in series. A third rectifying diode and a fourth rectifying diode are connected in series between the first and the second rectifying diodes, the third and the fourth rectifying diodes having a first node therebetween. A first capacitor and a second capacitor are connected in series between the first and the second rectifying diodes and in parallel with the third and the fourth rectifying diodes, the first and the second capacitors have a second node therebetween. A second charging unit is connected in parallel with the first charging unit. The second charging unit comprises a fifth rectifying diode and a sixth rectifying diode connected in series. A seventh rectifying diode and an eighth rectifying diode are connected in series between the fifth and the sixth rectifying diodes, the seventh and the eighth rectifying diodes have a third node therebetween. A third capacitor and a fourth capacitor are connected in series between the fifth and the sixth rectifying diodes and in parallel with the seventh and the eighth rectifying diodes, the third and the fourth capacitors have a fourth node therebetween. A lighting unit is connected in parallel with the first and the second charging units. The lighting unit comprises a resistor and at least one LED connected in series. Each of the rectifying diodes are biased toward the at least one LED, the first and the fourth nodes are connected with a first connector, and the second and the third nodes are connected with a second connector. An AC power supply is configured and disposed to impart a voltage between the first and second connectors.

In another aspect of the present disclosure, a voltage rectifier comprises a first charging unit and a second charging unit connected in parallel. The first and the second charging units each comprise a first rectifying diode and a second rectifying diode connected in series. A third and a fourth rectifying diode are connected in series between the first and the second rectifying diodes and have a connecting node therebetween. A first capacitor and a second capacitor are connected in series between the first and the second rectifying diodes and in parallel with the third and the fourth rectifying diodes, and have a connecting node therebetween. A first connector is configured and disposed to connect the connecting node between the third and the fourth rectifying diode of the first charging unit to the connecting node between the first and the second capacitor of the second charging unit. A second connector is configured and disposed to connect the connecting node between the first and the second capacitor of the first charging unit to the connecting node between the third and the fourth rectifying diode of the second charging unit. The voltage rectifier is configured to connect at least one load in parallel with the first and the second charging units.

In a further aspect of the present disclosure, a voltage rectifier comprises a first charging unit and a second charging unit connected in parallel. The first and the second charging units each comprise a first diode and a second diode connected in series and have a first connecting node therebetween. A first capacitor and a second capacitor are connected in series and have a second connecting node therebetween. A third diode and a fourth diode are connected in series and have the first and second diodes and the first and second capacitors connected in parallel therebetween. The first connector of the first charging is connected with the second connector of the second charging unit and the second connector of the first charging is connected with the first connector of the second charging unit. The voltage rectifier is configured to connect at least one load in parallel with the first and the second charging units.

### BRIEF DESCRIPTIONS OF THE DRAWINGS

The following figures, which are idealized, are not to scale and are intended to be merely illustrative of aspects of the present disclosure and non-limiting. In the drawings, like elements may be depicted by like reference numerals. The drawings are briefly described as follows.

FIG. 1A illustrates a schematic diagram of a known full wave voltage rectifier;

FIG. 1B illustrates a current waveform that flows through the full wave voltage rectifier illustrated in FIG. 1A;

FIG. 2A illustrates a schematic diagram of a known full wave voltage rectifier configured to smooth the output voltage waveform;

FIG. 2B illustrates a current waveform that flows through the full wave voltage rectifier illustrated in FIG. 2A;

FIG. 3A illustrates a schematic diagram of a known voltage rectifier having a pair of rectifying diodes in parallel with a pair of capacitors;

FIG. 3B illustrates a current waveform that flows through the voltage rectifier illustrated in FIG. 3A;

FIG. 4A illustrates a schematic diagram of a full wave voltage rectifier in accordance with one embodiment of the present disclosure;

FIG. 4B illustrates a current waveform that flows through the full wave voltage rectifier in accordance with the embodiment illustrated in FIG. 4A;

FIG. 5 is an expanded view of the schematic diagram of the full wave voltage rectifier illustrated in FIG. 4A; and

FIG. 6 illustrates a schematic diagram of a full wave voltage rectifier in accordance with another embodiment of the present disclosure.

### DETAILED DESCRIPTION

Reference will now be made in detail to the present exemplary embodiments and aspects of the present invention, examples of which are illustrated in the accompanying figures.

Wherever possible, the same reference numbers will be used throughout the figures to refer to the same or like parts.

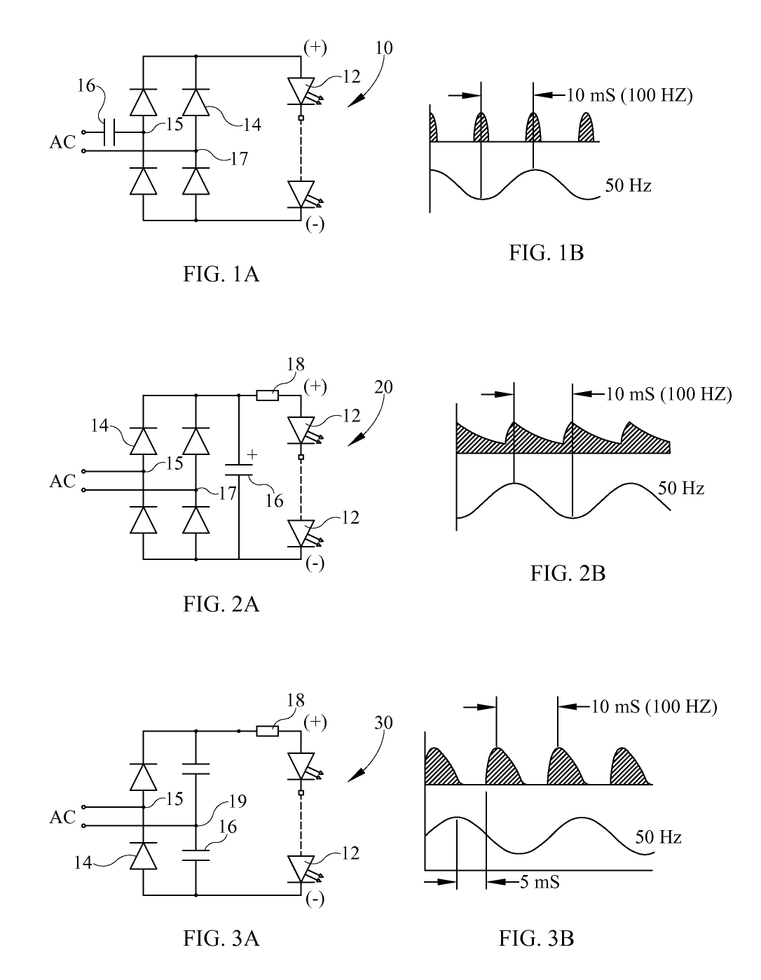

FIG. 1A illustrates a schematic diagram of a known full wave voltage rectifier 10 and FIG. 1B illustrates a current waveform that flows through full wave voltage rectifier 10. Full bridge or full wave rectifier 10 comprises four rectifying diodes 14, each biased toward a DC load, LEDs 12 in this example. An AC power supply is connected at nodes 15 and 17, between two rectifying diodes 14 connected in series wherein two series of rectifying diodes 14 are connected in parallel. A capacitor 16 may be disposed to filter the AC power input. For simplicity, this disclosure follows the convention model of current flow wherein current is assumed to flow through electrical conductors from positive to negative poles. When the AC current is positive at node 15, current flows from node 15 to the series of LEDs 12 and returns to the AC power supply via node 17. When the AC current is positive at node 17, current flows from node 17 to the series of LEDs 12 and returns to the AC power supply via node 15. In each case, the power supplied to LEDs 12 is positive resulting in a DC current being supplied to LEDs 12.

FIG. 1B shows an AC input wave form on the lower curve and a DC wave form generated with full bridge or full wave rectifier 10 on the upper curve. As shown in FIG. 1B, node 15 conducts the first half-cycle of the AC input signal and node 17 conducts the second half-cycle AC input signal. Since each diode 14 is biased toward LEDs 12, the circuit changes a sinusoidal waveform with no DC component (zero average value) to one with a DC component, little or no negative value. However, the DC wave form may have zero values. This implementation may not be preferred in driving some DC devices such as LEDs 12.

FIG. 2A illustrates a schematic diagram of a known full wave voltage rectifier 20 and FIG. 2B illustrates a current waveform that flows through full wave voltage rectifier 20. Full bridge or full wave rectifier 20 comprises four rectifying diodes 14, each biased toward a DC load, LEDs 12 in this example. An AC power supply is connected at nodes 15 and 17, between two rectifying diodes 14 connected in series wherein the two series of rectifying diodes 14 are connected in parallel. A capacitor 16 is connected in parallel with the two sets of rectifying diodes 14. A resistor 18 is connected in series with LEDs 12. When the AC current is positive at node 15, current flows from node 15 to the series of LEDs 12 and returns to the AC power supply via node 17. When the AC current is positive at node 17, current flows from node 17 to the series of LEDs 12 and returns to the AC power supply via node 15. In each case, the power supplied to LEDs 12 is positive. The capacitor 16 and resistor 18 may smooth the DC wave form as shown in FIG. 2B.

FIG. 2B shows the AC input wave form on the lower curve and the DC wave form generated with full bridge or full wave rectifier 20 on the upper curve. As shown in FIG. 2B, node 15 conducts the first half-cycle of the AC input signal and node 17 conducts the second half-cycle AC input signal. Since each diode 14 is biased toward LEDs 12, the circuit changes a sinusoidal waveform with no DC component to one with a DC component. However, the DC wave form may have voltage peaks spaced by half a voltage cycle of the AC input wave form. This implementation may not be preferred in driving some DC devices such as LEDs 12.

FIG. 3A illustrates a schematic diagram of a known wave voltage rectifier 30 and FIG. 3B illustrates a current waveform that flows through wave voltage rectifier 30. Bridge or wave rectifier 30 comprises two rectifying diodes 14 with node 15 therebetween. Each diode 14 is biased toward a DC load, LEDs 12 in this example. Two capacitors 16 are connected in series and in parallel with the two rectifying diodes 14 and have node 19 therebetween. An AC power supply is connected at nodes 15 and 19, between rectifying diodes 14 and capacitors 16. A resistor 18 is connected in series with LEDs 12. The power supplied to LEDs 12 is positive or zero throughout the AC input wave form. However, as shown in FIG. 3B, the DC wave form may have zero values and may have voltage peaks spaced by half a voltage cycle of the AC input wave form. This implementation may not be preferred in driving some DC devices such as LEDs 12.

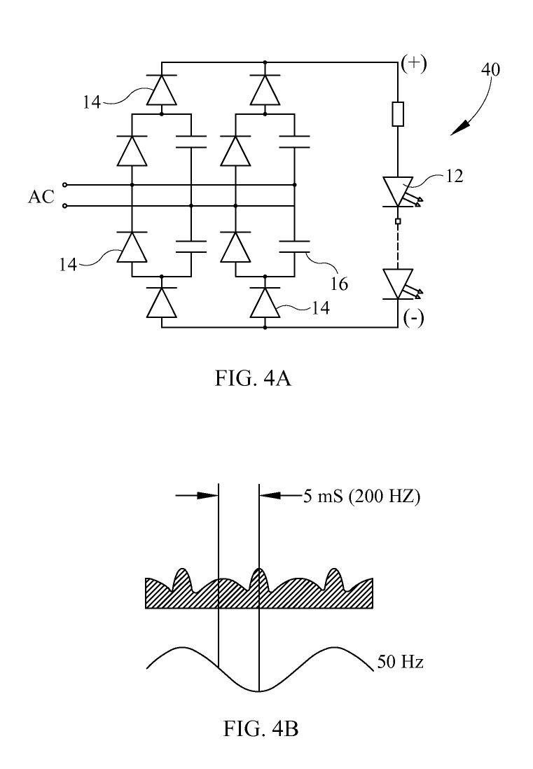

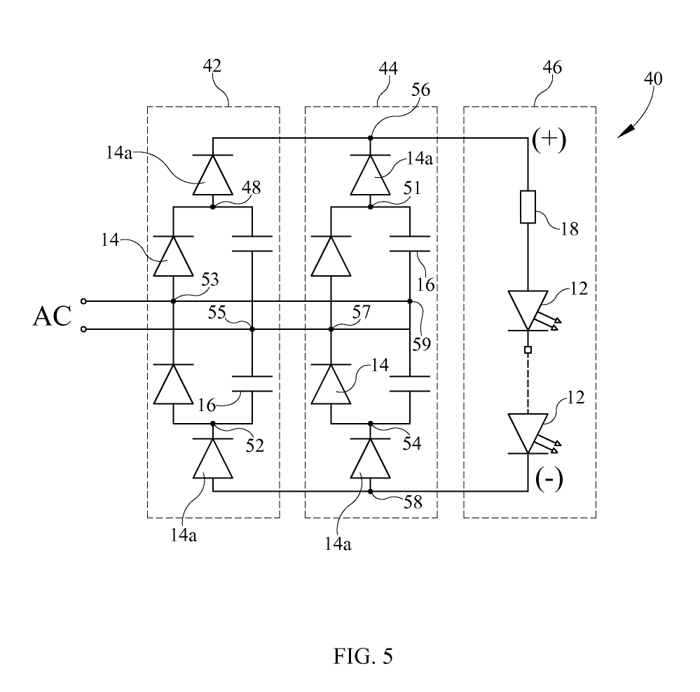

FIGS. 4A and 5 show an aspect of a full wave voltage rectifier of the present disclosure. Voltage rectifier 40 comprises a first charging unit 42 connected in parallel with a second charging unit 44, at nodes 56 and 58. First charging unit 42 comprises a first rectifying diode 14a and a second rectifying diode 14a connected in series. A third rectifying diode 14 and a fourth rectifying diode 14 are connected in series between first and second rectifying diodes 14a. Third and fourth rectifying diodes 14 have node 53 therebetween. A first capacitor 16 and a second capacitor 16 are connected in series between first and the second rectifying diodes 14a and in parallel with third and the fourth rectifying diodes 14. First and second capacitors 16 have node 55 therebetween.

Second charging unit 44 is connected in parallel with first charging unit 42 at nodes 56 and 58. Second charging unit 44 comprises a fifth rectifying diode 14a and a sixth rectifying diode 14a connected in series. A seventh rectifying diode 14 and an eighth rectifying diode 14 are connected in series between fifth and the sixth rectifying diodes 14a. Seventh and the eighth rectifying diodes 14 have node 57 therebetween. A third capacitor 16 and a fourth capacitor 16 are connected in series between fifth and the sixth rectifying diodes 14a and in parallel with seventh and the eighth rectifying diodes 14. Third and fourth capacitors 16 have node 59 therebetween.

A lighting unit 46 is connected in parallel with first charging unit 42 and second charging unit 44. Lighting unit 46 comprises a resistor 18 and at least one LED 12. In at least one aspect of the present disclosure, lighting unit 46 comprises two or more LEDs connected in series. For example, lighting unit 46 may comprise about 33 LEDs 12 connected in series and voltage rectifier 40 may be configured to drive lighting unit 46 with a standard 120Volt AC power supply. In another aspect lighting unit 46 may comprise about 60 LEDs 12 connected in series and voltage rectifier 40 may be configured to drive lighting unit 46 with a 230 Volt AC power supply. Each rectifying diode 14 and 14a are biased toward the at least one LED 12. Nodes 53 and 59 are connected with a first connector and nodes 55 and 57 connected with a second connector. An AC power supply is configured and disposed to impart a voltage between the first and second connectors.

FIG. 4B shows the AC input wave form on the lower curve and the DC wave form generated with voltage, full bridge, or full wave rectifier 40 on the upper curve. As shown in FIG. 4B, the circuit changes a sinusoidal waveform of the AC input wave to a DC wave form. The DC wave form generated with voltage rectifier 40 may comprise values greater than zero throughout the complete AC wave cycle. Additionally, voltage peaks may be smoothed and spaced by only a quarter a voltage cycle of the AC input wave form. The wave form shown in FIG. 4B, which may be produced with voltage rectifier 40, may be advantageous in driving devices that may have improved performance characteristics associated with substantially continuous and substantially smooth DC current supplied thereto. For example, LEDs 12 may exhibit increased performance such as a increased light output, decreased flicker, and/or longer life when driven with voltage rectifier 40.

For example, FIG. 4A shows that a 50 HZ input may generate a ripple of 200 Hz. A typical low cost passive power supplier/driver of the prior art generates only a ripple of 100 Hz, as shown in FIGS. 1A, 2A, and 3A. As is known in the art, a 100 Hz ripple may be recognized by the human eye as slight flickering. The 200 Hz ripple that may be generated with aspects of a voltage rectifier disclosed herein may not be recognizable by the human eye. Therefore, aspects of the present disclosure may provide a power supplier with less ripple (current ripple) and lower cost.

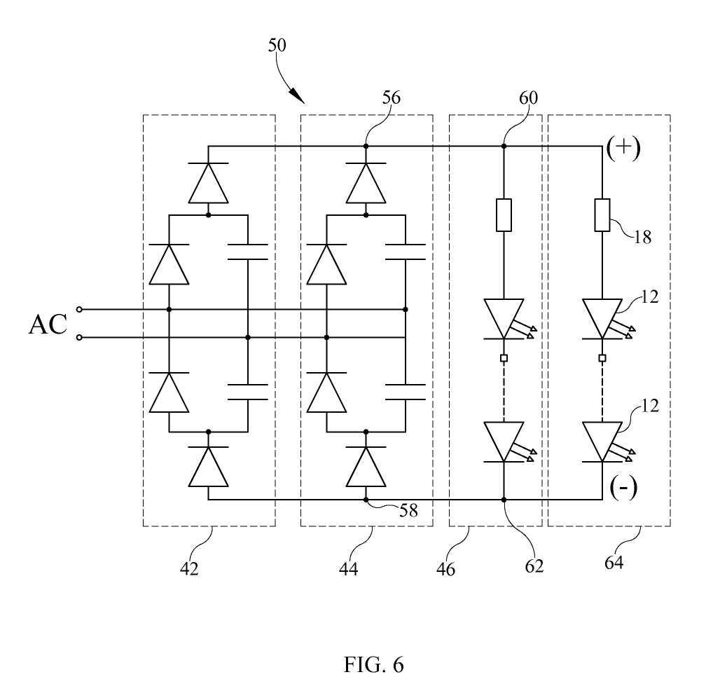

FIG. 6 shows another aspect of a full wave voltage rectifier of the present disclosure. Voltage rectifier 50 comprises first charging unit 42 connected in parallel with second charging unit 44, at nodes 56 and 58. Lighting unit 46 is connected in parallel with first charging unit 42 and second charging unit 44. A lighting unit 64 is connected in parallel with first charging unit 42, second charging unit 44, and in parallel with lighting unit 46, at nodes 60 and 62. Lighting units 46 and 64 may comprise a resistor 18 and at least one LED 12. In at least one aspect, lighting units 46 and 64 each have a plurality of LEDs 12 connected in series. For example, lighting units 46 and 64 may each comprise about 33 LEDs 12 connected in series and voltage rectifier 50 may be configured to drive lighting unit 46 with a standard 120 Volt AC power supply. In another aspect of the present disclosure, voltage rectifier 50 comprises more than two lighting units connected in parallel with charging units 42 and 44 and each lighting unit may comprise one or more LEDs 12.

The LEDs 12 may comprise conventional semiconductor light emitting diodes or organic or polymeric light emitting diodes. Additionally, LEDs 12 comprise one or a combination of Red, Green, Blue, White (RGBW) LEDs; RGBW- Amber LEDs; LEDs of different color temperature; LEDs having the same color; or Blue/UV-LEDs in combination with a remote phosphor disposed with light transmissible panels. Other and different LEDs, as known by one skilled in the art, and combinations thereof may be driven with voltage rectifiers 40 and 50.

Aspects of the present disclosure may provide an AC/DC voltage rectifier configured to output a more smooth DC voltage wave form and/or a DC wave form with little or no zero values. Aspects of the present may also provide a driver configured to drive one or more LEDs. The invention is illustrated by example in the drawing figures, and throughout the written description. It should be understood that numerous variations are possible while adhering to the inventive concept. Such variations are contemplated as being a part of the present disclosure.

### AT LEAST A PARTIAL LIST OF NOMENCLATURE

10 Voltage Rectifying Unit
12 Light Emitting Diode (LED)
14 Rectifying Diode
15 Node
16 Capacitor
17 Node
18 Resistor
19 Node
20 Voltage Rectifying Unit
30 Voltage Rectifying Unit
40 Voltage Rectifying Unit
42 Charging Unit
44 Charging Unit
46 Lighting Unit
48 Node
50 Voltage Rectifying Unit
51 Node
52 Node
53 Node
54 Node
55 Node
56 Node
57 Node
58 Node
59 Node
60 Node
62 Node
64 Lighting Unit

1. A voltage rectifying unit comprising:
a first charging unit;
said first charging unit comprising:
a first rectifying diode and a second rectifying diode connected in series;
a third rectifying diode and a fourth rectifying diode connected in series between said first and said second rectifying diodes, said third and said fourth rectifying diodes having a first node therebetween;
a first capacitor and a second capacitor connected in series between said first and said second rectifying diodes and in parallel with said third and said fourth rectifying diodes, said first and said second capacitors having a second node therebetween;
a second charging unit connected in parallel with said first charging unit,
said second charging unit comprising:
a fifth rectifying diode and a sixth rectifying diode connected in series;
a seventh rectifying diode and an eighth rectifying diode connected in series between said fifth and said sixth rectifying diodes, said seventh and said eighth rectifying diodes having a third node therebetween;
a third capacitor and a fourth capacitor connected in series between said fifth and said sixth rectifying diodes and in parallel with said seventh and said eighth rectifying diodes, said third and said fourth capacitors having a fourth node therebetween;
a first lighting unit connected in parallel with said first and said second charging units,
said first lighting unit comprising:
a resistor and at least one LED connected in series;
each said rectifying diode being biased toward said at least one LED;
said first and said fourth nodes being connected with a first connector;
said second and said third nodes being connected with a second connector; and
an AC power supply configured and disposed to impart a voltage between said first and second connectors.

2. The voltage rectifying unit of claim 1 wherein said lighting unit comprises two or more LEDs connected in series.

3. The voltage rectifying unit of claim 1 further comprising a second lighting unit connected in parallel with said first and said second charging units and said first lighting unit.

4. A voltage rectifier comprising:
a first charging unit and a second charging unit connected in parallel;
said first and said second charging units comprising:
a first rectifying diode and a second rectifying diode connected in series;
a third and a fourth rectifying diode connected in series between said first and said second rectifying diodes and having a connecting node therebetween;
a first capacitor and a second capacitor connected in series between said first and said second rectifying diodes and in parallel with said third and said fourth rectifying diodes, and having a connecting node therebetween;
a first connector configured and disposed to connect said connecting node between said third and said fourth rectifying diode of said first charging unit to said connecting node between said first and said second capacitor of said second charging unit;
a second connector configured and disposed to connect said connecting node between said first and said second capacitor of said first charging unit to said connecting node between said third and said fourth rectifying diode of said second charging unit; and
said voltage rectifier being configured to connect at least one load in parallel with said first and said second charging units.

5. The voltage rectifier of claim 4 wherein each said rectifying diode is biased toward a load connected thereto.

6. The voltage rectifier of claim 5 having a load comprising at least one LED connected thereto.

7. The voltage rectifier of 6 wherein said load comprises a resistor connected in series with said at least one LED.

8. The voltage rectifier of claim 4 having a first load and a second load connected thereto, said first load being connected in parallel with said second load and said first and said second charging units.

9. The voltage rectifier of claim 8 wherein said second load comprises at least one LED.

10. The voltage rectifier of claim 8 having a third load connected thereto, said third load being connected in parallel with said first and second loads and said first and said second charging units.

11. The voltage rectifier of claim 10 wherein said third load comprises at least one LED.

12. A voltage rectifier comprising:
a first charging unit;
a second charging unit connected in parallel with said first charging unit;
said first and said second charging units comprising:
a first diode and a second diode connected in series and having a first connecting node therebetween;
a first capacitor and a second capacitor connected in series and having a second connecting node therebetween;
a third diode and a fourth diode connected in series and having said first and said second diodes and said first and said second capacitors connected in parallel therebetween;
a first connector configured and disposed to connect said first connecting node of said first charging unit with said second connecting node of said second charging unit;
a second connector configured and disposed to connect said second connecting node of said first charging unit with said first connecting node of said second charging unit; and
said voltage rectifier being configured to connect to at least one load in parallel with said first and said second charging units.

13. The voltage rectifier of claim 12 further comprising an AC power source disposed to apply voltage between said first connector and said second connector, said voltage rectifier being configured to provide a continuously positive wave form to at least one load connected thereto, throughout a complete cycle of an AC input wave form.

14. The voltage rectifier of claim 12 further comprising an AC power source disposed to apply voltage between said first connector and said second connector, said voltage rectifier being configured to generate peaks in a wave form at about each quarter of a cycle of the AC input wave form.

15. The voltage rectifier of claim 14 configured to generate a 200 Hz current ripple in a DC current with a 50 Hz AC power source.

16. The voltage rectifier of claim 12 further comprising a resistor disposed to be in series with at least one load connected thereto.

17. The voltage rectifier of claim 12 having a first load connected thereto, said first load comprising one or more LEDs.

18. The voltage rectifier of claim 12 having a first load and a second load connected thereto, said first and said second loads being connected in parallel with each other and said first and said second charging units.

19. The voltage rectifier of claim 18 having a third load connected thereto, said third load being connected in parallel with said first and said second loads and said first and said second charging units.

20. The voltage rectifier of claim 19 wherein said third load comprises one or more LEDs.
